(19) United States
(12) Patent Application Publication
(10) Pub. No.: US 2008/0068644 A1
(43) Pub. Date: Mar. 20, 2008

(54) CLIENT APPARATUS, METHOD OF COMMUNICATING AND COMPUTER PROGRAM

(76) Inventor: Hideki Yanagi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/849,558

(22) Filed: Sep. 4, 2007

(30) Foreign Application Priority Data
Sep. 15, 2006 (JP) 2006-250195
Aug. 8, 2007 (JP) 2007-213287

(51) Int. Cl. G06F 3/12

(52) U.S. Cl. 358/1.15

(57) ABSTRACT

A client apparatus connected to a network and including a communication device configured to receive a program, including a driver for controlling a communicable apparatus connected to the network and a communication module for communicating to the communicable apparatus, and a communicable apparatus information including port information and IP address from a server connected the network, and communicating with the communicable apparatus by using the IP address and assigning a port based on the port information.

### BACKGROUND OF THE INVENTION

1. Field of the Invention

The present invention generally relates to a client apparatus connected to network and communicating method in a client apparatus. More particularly, the invention relates to a technique for downloading program for communicating a communicable apparatus connected to the client apparatus via the network.

2. Discussion of the Background

In recent years, printer sharing systems have been widely to accommodate plural computers sharing a single printer. The conventional printer sharing system includes a server, plural computers and an image forming apparatus (e.g., a printer). After the server receives instruction to print from the computers via network, the server sends print instructions to the printer. The computer uses a driver for accessing and sharing the printer. The driver is provided by the server via network or by a storage media (e.g., CD-ROM).

But conventional drivers are not available for two-way communication, so the computer does not get the latest printer information under Point & Print environment. Point & Print is a technique for sharing printers by using a server. The computer doesn't have a module for two-way communication with printer, and the computer's operating system communicates with the server by predetermined sequence. Under the Point & Print environment, the computer requests to server for sending the driver, and downloads the driver. The computer can print by using spooler in the server. The spooler is a program that storage data, example for print data, temporarily, if the server sends to data to slowly processing apparatus like the printer. However port is not opening between the computer and the printer. So the computer doesn't get information of the printer situation.

The port is available, if the computer has special software that opens port to communicate with the printer. But it is necessary to install the special software to the computer by user. That is burden for user.

Then JP 2006-79138A identifies a way for a computer to obtain information about a printer status from a server connected the printer via network. In the process described in JP 2006-79138A, the computer does not need to have Point & Print or related software. But the process described in JP 2006-79138A suffers from degraded network performance when faced with an increasing number of communication and quantity of communication between the computer and the server.

### SUMMARY OF THE INVENTION

The present invention provides a client apparatus, and method of communicating in a client apparatus, for communicating between a client apparatus and communicable apparatus.

In one embodiment, a client apparatus is connected to a network and includes a communication device configured to receive a program, including a driver for controlling a communicable apparatus connected to the network and a communication module for communicating to the communicable apparatus, and a communicable apparatus information including port information and address from a server connected the network, and communicate with the communicable apparatus by using the address and assigning a port based on the port information.

Another embodiment includes a method of communicating in a client apparatus. The method includes receiving a program including a driver for controlling a communicable apparatus connected to the network and a communication module for communicating to the communicable apparatus, and a communicable apparatus information including port information and address from a server connected the network; and communicating with the communicable apparatus by using the address and assigning a port based on the port information.

### BRIEF DESCRIPTION OF THE DRAWINGS

FIG. 1 is an illustrative drawing showing a network system including a client apparatus according to the present invention;

FIG. 2 is a block diagram showing an example of the construction of the server, a printer as the communicable apparatus and a personal computer as the client apparatus;

FIG. 3 is an example of table of the port information;

FIG. 4 is a block diagram showing an example of the construction of the server, a printer and a personal computer in a scenario where a print job occurs and the personal computer and the printer communicate with each other;

FIG. 5 is a flow chart exemplarily showing a procedure for two-way communication between the personal computer and the printer;

FIG. 6 is an example of the MIB information;

FIG. 7 is a block diagram showing an example of the construction of the server 120, a printer and other printer and a personal computer when a print job occurs, and where the personal computer and the printer or the other printer communicate with each other.

### DETAILED DESCRIPTION OF THE INVENTION

An embodiment of the present invention provides a client apparatus and method of communicating in a client apparatus for communicating between a client apparatus and communicable apparatus.

In the following, embodiments of the present invention will be described with reference to the accompanying drawings.

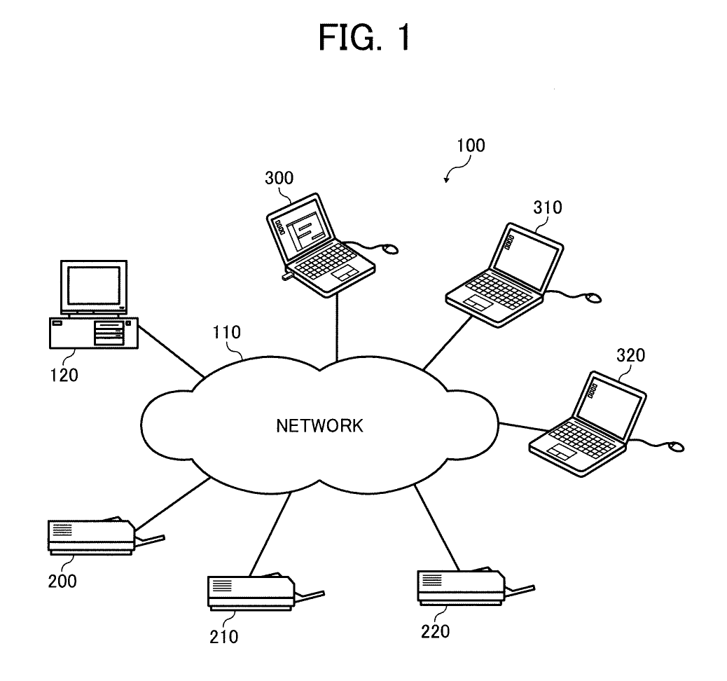

FIG. 1 is an illustrative drawing showing a network system including a client apparatus according to the present invention. In FIG. 1, a network system 100 includes a network 110, a server 120 connected to the network 110, a communicable apparatus 200, 210 and 220 connected the network 110, and a client apparatus 300, 310 and 320 connected the network 110.

The network 110, for example Internet or Intranet, is connected to the server 120, the communicable apparatus 200, 210 and 220, and the client apparatus 300, 310 and 320. The network 110 enables the server 120, the communicable apparatus 200, 210 and 220, and the client apparatus 300, 310 and 320 to communicate each other.

The server 120 has a memory that stores plural programs including: an operating system program, a driver that is used for sending instructions to the communicable apparatus 200, 210 and 220, a two-way communication module that enables two-way communications with the communicable apparatus 200, 210 and 220, and a processor that processes these programs.

The communicable apparatus 200, 210 and 220 is apparatus that is available to communicate with the client apparatus 300, 310 and 320 via the network 110. Examples of communicable apparatus 200, 210 and 220 include an image forming apparatus or digital camera that has network interface etc. The image forming apparatus may be a laser printer, inkjet printer, scanner, facsimile, or multiple function printer that has function of a printer, scanner and facsimile.

The client apparatus 300, 310 and 320 is personal computer that has a memory and processor.

The server 120, the communicable apparatus 200, 210 and 220, and the client apparatus 300, 310 and 320 has a network interface and can communicate in two directions by using a specific protocol (e.g., TCP/IP, UDP, HTTP, FTP, SNMP, or Line Printer Daemon (LPD) protocol).The system uses a distinguishable address, for example ID address, for each of the server 120, the communicable apparatus 200, 210 and 220, and the client apparatus 300, 310 and 320.

It is possible to distinguish between the server 120 and the communicable apparatus 200, 210 and 220, and between the server 120 and the client apparatus 300, 310 and 320 by using unique IP addresses. But services provided by each apparatus are not distinguishable by merely using IP addresses. Thus, port numbers (sub addresses) are used to distinguish between the services. Therefore, network addresses (sockets) that are a combination of an IP address and a port number, are used to distinguish the service.

Some port numbers are predetermined (e.g., port number 20 and 21 is used by FTP, port number 80 is used by HTTP, port number 161 is used by SNMP, and port number 515 is used by LPD.) The communicable apparatus 200, 210 and 120 can designate one of the above port numbers by selecting the corresponding protocol. Thus, a designated port number can be opened for communication between the communicable apparatus 200, 210 and 220 and server 120 or the client apparatus 300, 310 and 320.

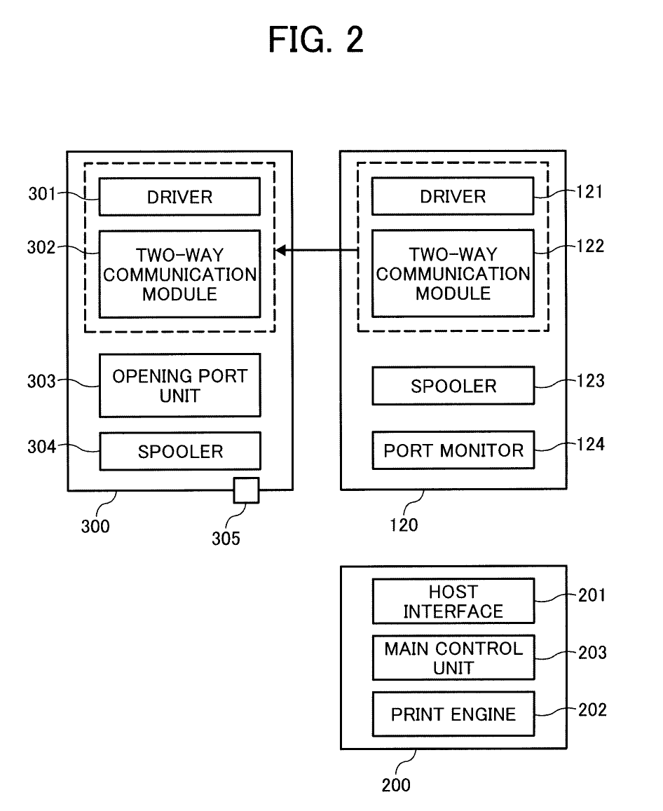

FIG. 2 is a block diagram showing an example of the construction of the server 120, a printer 200 as the communicable apparatus, and a personal computer 300 as the client apparatus.

The server 120 has a driver 121 that outputs print data related to image data made by an application. The server 120 also has a two-way communication module 122 that is used for communicating between the server 120 and the printer 200. The server 120 also has spooler 123 that spools the print data temporarily. The server 120 also has a port monitor 124 that monitors communications between the server 120 and the printer 200, and outputs the print data to printer 200. The two-way communication module 122 stores port information for communicating to the printer 200.

The printer 200 has host interface 201 for receiving the print data, print engine 202 for outputting print data, and main controlling unit 203 for controlling the host interface 201 and the print engine 202.

The personal computer 300 has a driver 301 and a two-way communication module 302 downloaded from the server 120. The personal computer 300 also has an opening port unit 303 and spooler 304.

The personal computer 300 requests that the server 120 send the driver 121 and the two-way communication module 122 to the personal computer 300. In response, the server 120 makes a copy of the driver 121 and the two-way communication module 122 and sends the copied driver 121 and two-way communication module 122 to the personal computer 300. The server 120 also sends port information that is used for communication with the printer 200. The port information includes port number, kind of protocol, ID address of the printer 200, etc.

The personal computer 300 receives the driver 121 as the driver 301 and installs the driver 121 by using an installer program in the personal computer 300.

The two-way communication module 302 finds printer's IP address from the port information.

The computer's port opening unit 303 opens a port for communication based the printer's IP address, with the printer 200 by assigning a corresponding port number. The personal computer 300 then constructs communication entry point 305. The port opening unit 303 can close communication entry point 305 by releasing the assigned port number. The port number is assigned based on the type of communication with the printer 200, for example FTP uses predetermined port number 20 and 21, HTTP uses predetermined port number 80, SNMP used predetermined port number 161, and LPD uses predetermined port number 515. Alternatively, personal computer 300 can use assign a different port number for any function listed above.

The personal computer 300 includes a spooler 304. The spooler 304 stores print data temporarily and sends the print data to the server 120 sequentially.

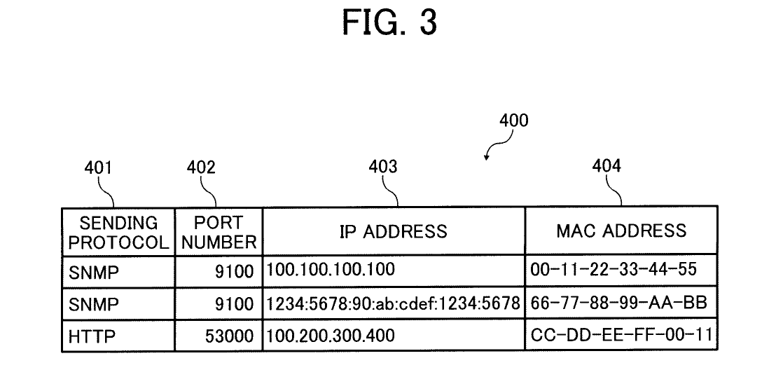

FIG. 3 is an example of a table of the port information stored in the server 120.

The table of port information 400 includes the sending protocol type 401, port number 402, IP address 403, and MAC address 404. For example, if the printer 300 is set up as IP address 100.100.100.100, the type of sending protocol 401 is SNMP, the port number 402 is 9100, and MAC address 404 is 00-11-22-33-44-55.

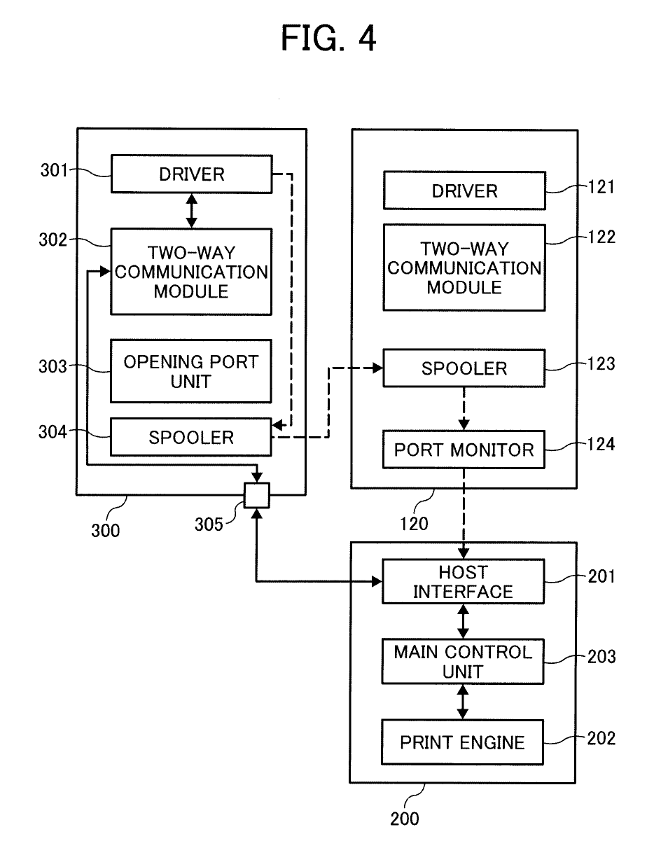

FIG. 4 is a block diagram showing an example of the construction of the server 120, a printer 200 as the communicable apparatus and a personal computer 300 as the client apparatus. When q print job occurs, the personal computer 300 and the printer 200 communicate with each other.

FIG. 4 shows an example where the personal computer already has installed the driver 301 and two-way communication module 302. Therefore, the personal computer 300 already has established communication entry point 305 and therefore can communicate with the printer 200 directly by using opened port.

The personal computer 300 outputs print data, which is made by an application not shown in FIG. 4, by using the driver 301. The personal computer 300 temporarily stores the print data in spooler 304 and sends the print data to the server 120. The server 120 stores the print data in spooler 124. The server 120 monitors the status of the printer 200 by using port monitor 124. The server 120 sends print data stored in spooler 123, once the server 120 detects the printer 200 is available for printing. The printer 200 receives the print data by using host interface 201. The printer 200 prints by using the main controlling unit 203 for controlling the print engine 202.

The server may store plural print data files in spooler 123, because printing at the printer 200 takes time. The server 123 sends the print data to printer 200 sequentially as the print jobs at printer 200 complete. The server 120 may receive print data from plural personal computers 300, 310 and 320 at the same time. The spooler 304 is available for storing print data if data volume is huge and the server 120 cannot store the print data. Therefore, the personal computer 300, 310 and 320 has spooler 304. The computer 300, 310 and 320 can send the print data to the server 120 with timing appropriate to the spooler situation. The spoolers 123 and 304 send their respective print data as FIFO (First In, First Out).

Contrary to conventional systems, the personal computer 300 communicates with the printer 200 directly to receive information about the printer 200 (for example, optional apparatus information, attached unit information, and situation information of the printer 200, etc.) via the port opened between the two-way communication module 302 and the host interface 201. Because the personal computer 300 can communicate to the printer 200 directly, the personal computer 300 can receive information about the printer 200 without waiting for the spooler 123 at the server 120 to complete local data processing. The optional apparatus information may be information about ink supplies, feeding tray information, setting tray information, stapling information, punch information, etc. The information about the printer 200 may be printer wait times, error information, etc.

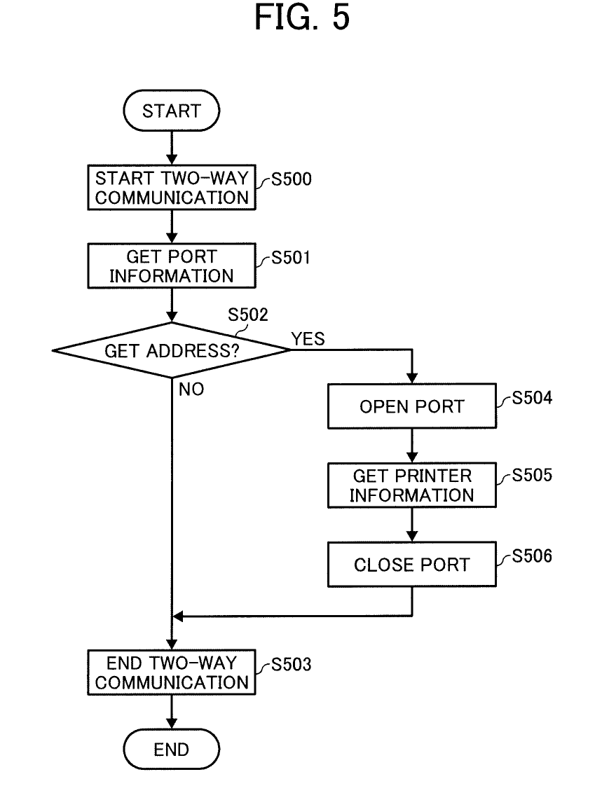

FIG. 5 is a flow chart exemplarily showing procedure of two-way communication between the personal computer 300 and the printer 200.

The driver 301 starts two-way communication (step S500).

The two-way communication module 302 retrieves the port information of the driver 301 previously downloaded from server 120 (step S501) for use in direct communication with the printer 200. The port information of the driver 301 is same as the port information of the driver 121, cause the driver 301 is copy of the driver 121 stored in the server 120, So the port information includes IP address, MAC address, protocol, port number, etc, used for communicating between the server 120 and the printer 200. The IP address is used for distinguishing the printer 200. If the two-way communication module 302 cannot get an IP address (step S502; NO), the procedure is ends (step S503). If the two-way communication module 302 can get an IP address (step S502; YES), the two-way communication module 302 assignees a port number and opens the port (step S504). The two-way communication module 302 sends a printer status to the printer 200 by using the IP address. The status request includes the IP address of the personal computer 302 and the opened port number. The printer 200 receives the IP address of the personal computer 300 and opened port number from the personal computer 300, and sends the requested status information to the personal computer 300 by using the received IP address and opened port number of the personal computer 300.

The two-way communication module 302 receives the status information of the printer 200 (step S505).

Then, the two-way communication 302 closes the port (step S506) and ends the two-way communication (step S503).

The personal computer 300 can display the status information received from the printer 200 through a user interface of the driver 301.

The personal computer 300 can store the status information received from the printer 200. Status information may be about the printer itself (paper supply, paper jam, copy selections (one-side, both-side, collate, landscape, portrait, etc.) and other features) or about a peripheral/optional device (e.g., staple status, stapling orientation, paper punch status and orientation, etc.) Therefore, the personal computer 300 can identify the printer 200 by using static information, which is a part of received information, (e.g., a MAC address if the printer is set up for using DHCP (Dynamic Host Configuration Protocol)). The personal computer 300 can also receive MIB information as part of the status information of the printer 200. The MIB information provides SNMP network information of the printer 200.

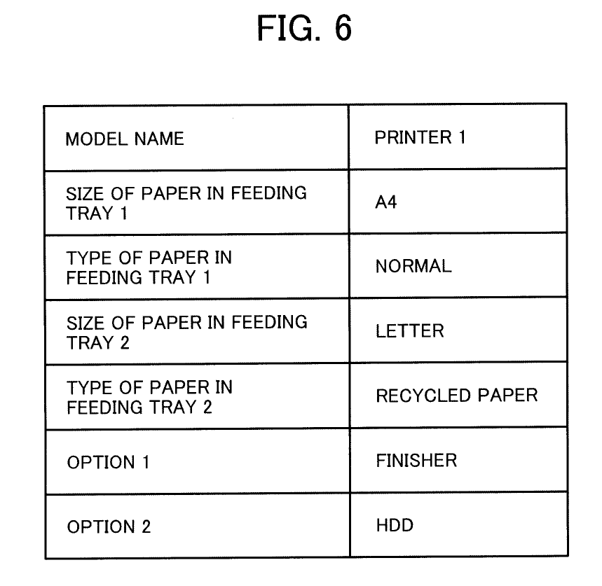

FIG. 6 is an example of the MIB information 600.

The MIB information 600 includes model name 601, size of paper at feeding tray 1 602, type of paper at feeding tray 1 603, size of paper feeding tray 2 604, type of paper at feeding tray 2 605, optional unit 1 606 and optional unit 2 607.

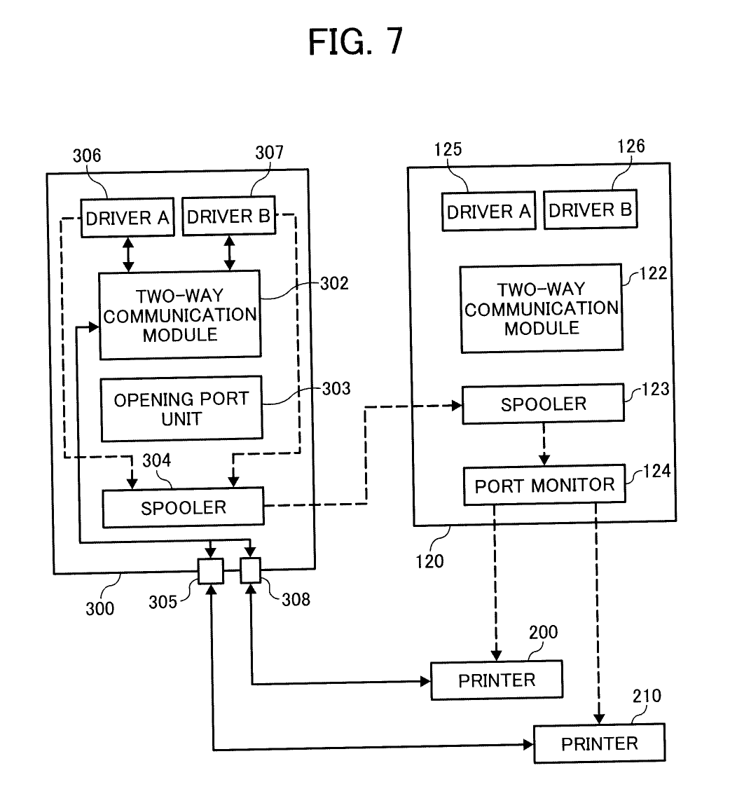

FIG. 7 is a block diagram showing an example of the construction of the server 120, a printer 200 and a printer 210 as the communicable apparatus and a personal computer 300 as the client apparatus when a print job occurs and the personal computer 300 and the printer 200 or the printer 210 communicate with each other.

The server 120 has a driver A 125 and B 126. The computer 300 has downloaded a copy of the driver A 125 as a driver A 306 and the driver B 126 as a driver B 307. The personal computer 300 can use the two-way communication module 302 for communicating with printers 200 and 210. The personal computer 300 downloads a copy of the two-way communication module 122 as two-way communication module 302 when the personal computer 300 downloads a copy of the driver A 125 and the driver B 126.

The personal computer 300 communicates with the printer 200 and 210 via port 305 and 308.

The personal computer 300 stores the print information to the spooler 304, and sends the print information to the spooler 123 of server 120. Then the server 120 sends the print information to the printer 200 and 210.

The personal computer 300 can use different types of protocol to communicate to the printer 200 and 210. For example, the personal computer can communicate with printer 200 by using SNMP, and communicate with printer 210 by using HTTP. The personal computer 300 adopts a suitable communication type according to the type of the host interface 201 (e.g., wireless LAN).

The invention may be implemented in software, so as to cause a processor-based device to execute the methods described previously. A tutorial on how computers and related devices operate may be found in “How Computers Work, Millennium Edition,” by Ron White, 1999, Que Publications, Macmillan Computer Publishing, USA.

The present invention is not limited to these embodiments, but various variations and modifications may be made without departing from the scope of the present invention.

The present application claims priority to corresponding Japanese Application No. 2006-250195 and 2007-213287, filed on Sep. 15, 2006 and Aug. 8, 2007, the entire contents of which are hereby incorporated by reference.

What is claimed is:

1. A client apparatus connected to a network, comprising:
a communication device configured to send to a server on said network a file to be printed by a communicable apparatus on said network, to receive port information including a network address of said communicable apparatus from the server, and to receive a program from the server, the program including
a driver for controlling the communicable apparatus connected to said network, and
a communication module for controlling communications between said client apparatus and said communicable apparatus,
said communication device further configured to assign an internal port based on said port information and to communicate with said communicable apparatus via said network address and said internal port.

2. The client apparatus is as claimed in claim 1, wherein said program includes a second driver for controlling a second communicable apparatus connected to said network.

3. The client apparatus is as claimed in claim 1, wherein said communication device is configured to receive via said internal port one of
status information concerning a device connected to said communicable apparatus, and
status information concerning an internal status of said communicable apparatus.

4. The client apparatus is as claimed in claim 1, wherein said communication device is further configured to receive protocol information concerning a protocol used for communication between said client apparatus and said communicable apparatus.

5. The client apparatus is as claimed in claim 1, wherein said communicable apparatus is one of a printer, a copier and a facsimile machine.

6. A method of communicating by a client apparatus connected to a network, comprising:
sending to a server on said network a file to be printed by a communicable apparatus;
receiving port information including a network address of said communicable apparatus from the server;
receiving a program from the server, the program including
a driver for controlling the communicable apparatus connected to said network, and
a communication module for controlling communications between said client apparatus and said communicable apparatus;
assigning an internal port based on said port information; and
communicating with said communicable apparatus via said network address and said internal port.

7. The method as claimed in claim 6, wherein said program includes a second driver for controlling a second communicable apparatus connected to said network.

8. The method as claimed in claim 6, wherein the step of receiving further comprises:
receiving via said internal port one of
status information concerning a device connected to said communicable apparatus, and
status information concerning an internal status of said communicable apparatus.

9. The method as claimed in claim 6, further comprising:
receiving protocol information concerning a protocol used for communication between said client apparatus and said communicable apparatus.

10. The method as claimed in claim 6, wherein said communicable apparatus is one of a printer, a copier and a facsimile machine.

11. A computer program stored in a computer readable storage medium and comprising instructions configured to cause a processor in a client device connected to a network to execute a method comprising:
sending to a server on said network a file to be printed by a communicable apparatus;
receiving port information including a network address of said communicable apparatus from the server;
receiving a program from the server, the program including
a driver for controlling the communicable apparatus connected to said network, and
a communication module for controlling communications between said client apparatus and said communicable apparatus;
assigning an internal port based on said port information; and
communicating with said communicable apparatus via said network address and said internal port.
